(19) United States
(12) Patent Application Publication
(10) Pub. No.: US 2023/0342584 A1
(43) Pub. Date: Oct. 26, 2023

(54) Boolean Reservoir Neural Networks

(71) Applicant: RapidSilicon US, Inc, Los Gatos, CA (US)

(72) Inventor: Valerio Tenace, Torino (IT)

(21) Appl. No.: 17/988,747

(22) Filed: Nov. 16, 2022

Related U.S. Application Data
(60) Provisional application No. 63/332,759, filed on Apr. 20, 2022.

(51) Int. Cl. G06N 3/04

(52) U.S. Cl. CPC G06N 3/04

(57) ABSTRACT

Technology is described for processing data using a Boolean reservoir and providing predictive output (e.g., classification or regression). The method can include receiving a plurality of inputs to an input layer of the neural network, and the inputs are Boolean inputs. One operation may be sending the inputs to a reservoir layer. The neurons in the reservoir layer may have a balanced output Boolean function and a plurality of neuron inputs. The inputs may be mapped to a modified dimensional space using balanced output Boolean functions in the reservoir layer. In another operation, mapped inputs may be read from the reservoir layer using a readout layer to provide predictive output (e.g., classification or regression) from the reservoir layer. A predictive output for the inputs may be indicated using at least one output neuron of the readout layer.

### PRIORITY DATA

This application claims the benefit of U.S. Provisional Pat. Application Serial No. 63/332,759, filed on Apr. 20, 2022, which is incorporated herein by reference.

### BACKGROUND

One possible driving force behind the surge of edge computing in the computing industry may be traced back to the opportunity to offload Artificial Intelligence (AI) or machine learning tasks to end-nodes, thus enabling execution of the analysis of sensor data to be processed locally, (i.e., near the sensors where physical signals are collected). In this way, human-environment interactions with an edge device (e.g., a mobile device) can be met with low latency responses to users’ inputs, since data does not need to travel to a centralized data center or cloud to be analyzed.

However, there are a few problems that may endanger the sustainability and effectiveness of edge computing. First, widely adopted AI techniques have, in several cases, an unfavorable trade-off between performance (i.e., accuracy) and hardware complexity. For instance, Convolutional (CNNs) and Recurrent Neural Networks (RNNs) are two of the most popular methods that are used in the context of image recognition and time series analyses, respectively. Although such solutions are capable of achieving high accuracy, the amount of data such methods produce per operation use memories with sizes that are incompatible with a resource-constrained system (usually in the order of several megabytes). Moreover, the number of operations performed, even for a single inference pass, typically uses several parallel compute units in order to achieve a reasonable throughput. Part of the problem is due to the fact that most CNNs, for instance, are over-parametrized by design. On the one hand, this allows better generalization capabilities. On the other hand, having too many parameters can represent an unjustifiable workload burden that, for most consumer-level applications, might be totally unnecessary.

Furthermore, typical hardware architectures are designed to accommodate specific CNN models or families of models, thus limiting the possibility to easily scale the complexity upon user request. To further emphasize this second caveat about hardware complexity, let us also consider the deployment of AI algorithms for sensor fusion applications (i.e., combining sensor data derived from disparate sources). Indeed, CNNs and RNNs are structurally designed to cope with the characteristics (shape, type of information) of the input signals they are configured or trained to work with. In other words, signals that belong to different domains, e.g., pictures and voice signals that could be used for an authentication system, are most accurately and/or efficiently processed individually with the most appropriate AI methodology. This implies the design of specific solutions to tackle particular applications, with a significant hardware overhead for splitting and preprocessing input data, and then merging output information. Such a segmentation between multiple predictive models also introduces additional challenges and difficulties during the training phase, which by itself already represents a time-consuming process using manual intervention for a productive fine-tuning.

### BRIEF DESCRIPTION OF THE DRAWINGS

FIG. 1 is block diagram illustrating an example architecture of a Boolean RCN.

FIG. 2 is a block diagram illustrating an example structure for a previously known Reservoir Computer Neural network.

FIG. 3 is an example of a graph illustrating the readout training curves of recurrent and non-recurrent RCN models, as trained on an image recognition task.

FIG. 4 is a block diagram illustrating an example of a previously known RCN neuron.

FIG. 5 depicts an example of a binary neuron (e.g., XOR gate) configuration to be used as one type of a Boolean RCN neuron.

FIG. 6 is a chart illustrating metrics used to compare Boolean RCNs to other types of CNNs (Convolutional Neural Networks).

FIG. 7 illustrates the use of a Boolean reservoir computing network (RCN) in the context of an image processing application.

FIG. 8 is a flow chart diagram illustrating a method for processing data using a Boolean reservoir computing network.

FIG. 9 illustrates a computing device on which modules of this technology may execute.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

The complexity of Convolutional (CNNs) and Recurrent Neural Networks (RNNs) poses several challenges to the efficient and effective execution of Artificial Intelligence (AI) algorithms on hardware-constrained devices. Reservoir Computing Networks (RCNs), on the other hand, entail a simpler and relatively shallow neural network model that leverages a randomly-drawn set of neurons coupled with an output readout classifier. Being able to handle diverse input applications, e.g., still images, time-series, RCNs represent an alternative to over-parametrized and over-designed CNNs/RNNs, especially when input stimuli can be represented using precision-scaling techniques as described later.

One effective AI technique for classification is Reservoir Computing Networks (RCNs), which are also known as Liquid State Machines or Echo State Networks. RCNs represent a class of neural networks composed of an input layer and a readout classifier, interleaved by a single non-trainable hidden layer, where input patterns are mapped to linearly-separable neuronal states. By leveraging randomly-initialized neurons interconnected by sparse synapses, the hidden layer provides an abstract multi-dimensional representation of the input stimuli to the output classifier, which represents the single trainable layer. For this reason, a typical RCN undergoes a supervised training phase that requires significantly less computation-intensive operations, a lighter structure, and a faster convergence towards a solution than many other deep neural networks.

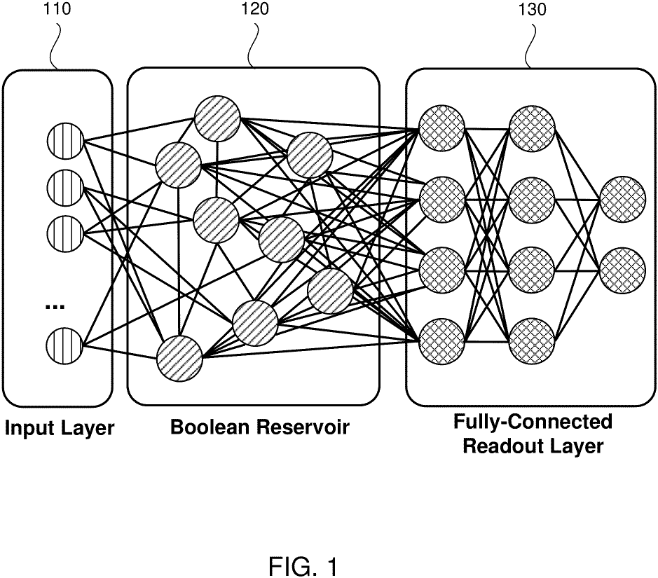

This technology describes the use of Boolean logic Reservoir Computing Networks (RCNs). This technology also describes the methods, systems, tools and architecture that compose a Boolean logic hidden layer tailored to RCNs. FIG. 1 illustrates that the present technology can use a reservoir structure or Boolean reservoir 120 that employs Boolean logic and receives data from an input layer 110. This results in a change to the RCNs′ feature extraction stage by replacing previously existing Multiply-and-Accumulate (MAC)-centric workloads with faster combinational logic networks.

In this Boolean reservoir or Boolean RCN architecture, the readout layer 130 can be implemented using multiple fully-connected layers for improved predictive performance. The readout layer 130 can provide classification, regression or other types of artificial intelligence analysis and output. This technology can enable a memory- and arithmetic-less feature extraction. This type of feature extraction may further reduce the resource requirements of a typical RCN, and at the same time, may lead to a more compact and effortless mapping on hardware devices. Preliminary results, conducted on open-source datasets, demonstrate that Boolean RCNs can achieve, in some cases, 61 times fewer MAC operations and 11 times fewer parameters when compared to similar existing CNN architectures used for classification.

### Previously Existing RCN Networks

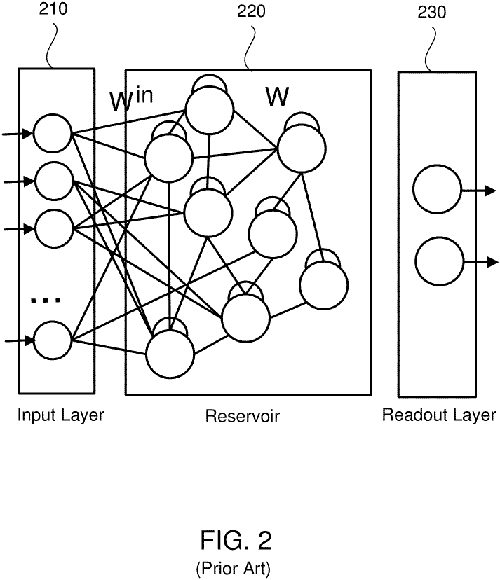

An RCN system is a 3-layer neural network consisting of an input layer 210, a reservoir (or hidden) layer 220, and an output (or readout) layer 230, as depicted in FIG. 2. The reservoir is composed of randomly-initialized and non-trainable synaptic connections that are used to map input pattern stimuli to linearly-separable neuronal states. In analogy to other more widespread AI solutions, such a layer performs a transformation of the input signal into a higher (or lower) dimensional space, thus functioning as a type of feature extraction operation on the input stimuli. A reservoir may have N hidden neurons, K inputs, and M output neurons. The fundamental equation that describes the working principle of the neural network is given in equation (1), where u(t) ∈ R^{K} is the input signal, x(t) represents the reservoir states that evolve in discrete time t ∈ Z, W ∈ R^{N×N} is the weight matrix of the reservoir, Wⁱⁿ ∈ R^{N×K} is the input weight matrix, and y(t) ∈ R^{M} is the output signal. Finally, ƒ(·) indicates the activation function of the hidden neurons.

$$x \left(t\right) = f \left(\text{Wx} \left(t - 1\right) + {\text{W}}^{i n} \text{u} \left(t\right)\right) \qquad \text{(1)}$$

The output response ŷ(t) of the RCN network is then a linear combination of the states of the reservoir at time t, as reported in equation (2) where W^{out} ∈ R^{M×(K+N)} is the output weight matrix, and g(·) is the output activation function.

$$\hat{y} \left(t\right) = g \left({\text{W}}^{\text{out}} \text{x} \left(t\right)\right) \qquad \text{(2)}$$

As previously stated, the reservoir’s weights are never updated, not being subject to any training phase. Therefore, the trainable parameters are the weights represented with W^{out}.

### Readout Training

During the training phase, an input perturbation signal at time t, i.e., u(t), is used to excite the hidden neuronal states in order to produce a given response ŷ(t). As a rule of thumb, the supervised training process of an RCN can be carried out by minimizing the difference between the predicted output ŷ and the actual expected output y via the Mean Square Error (MSE) reported in equation (3), where t ∈ T represents the time intervals of the training phase.

$$M S E = \frac{1}{T} {\sum }_{t = 1}^{T} {\left(\hat{y} \left(t\right) - y \left(t\right)\right)}^{2} \qquad \text{(3)}$$

Since every input stimuli u(t) yields a state vector x(t) coupled to a specific correct output value y(t), we can assume that a matrix X ∈ R^{T×(N)} represents all the extended state vectors obtained during the training phase, and a matrix Y ∈ R^{T×M} contains a collection of all the expected output values. At this point, W^{out} can be determined by substituting equation (2) in equation (3), hence obtaining equation (4), where X⁰ is the Moore-Penrose inverse of X.

$${\text{W}}_{\text{out}} = \text{X'} Y \qquad \text{(4)}$$

A readout layer with these characteristics represents a known existing approach. Later in this description, more detailed aspects of this technology will be described that enable the execution of complex classification tasks by means of multiple-layer readout implementations.

### Analysis

As can be derived from equation (1), a typical neuron in the reservoir layer depends on two different input contributions for determining its excitatory state: (i) primary inputs, or the main incoming signals, and (ii) incoming connections from other reservoir neurons, including its own recurring connection. Despite its associated activation function, the fundamental operation of a single neuron boils down to a MAC operation, as described in equation (5), where w ∈ R^{1×N} is a single component of the W matrix, and likewise wⁱⁿ ∈ R^{1×K} is a component of Wⁱⁿ.

$$x \left(t\right) = {\sum }_{N} \text{wx} \left(t - 1\right) + {\sum }_{K} {\text{w}}^{i n} \text{u} \left(t\right) \qquad \text{(5)}$$

By analyzing equation (5), two different results can be deduced for this technology.

### Result 1: Time Dependency Is Not Always Necessary

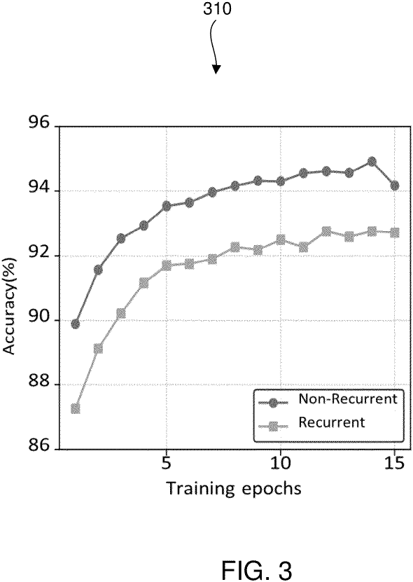

Being related to RNNs by nature, RCNs have been mainly utilized in time-series predictions, forecasting of continuous signals, or even as a resonating system. However, these applications share a common characteristic: the input stimuli are time dependent. Preserving such time dependency even when input signals represent uncorrelated samples (e.g., images or photos that do not belong to a single and continuous video stream) may lead to suboptimal responses from the RCN. Such a phenomenon is empirically demonstrated in FIG. 3, where the readout training curves 310 representing the prediction accuracy of two RCN models, trained on an image recognition task, are reported. The first model is a traditional RCN implementation, where, at each step, states at time t - 1 are used to determine the output of the predictive system at time t (square markers in FIG. 3). On the other hand, the second model assumes that x(t) is a constant that is randomly initialized only once (circle markers). As can be seen from the graph, the memory component introduces severe fluctuations in the learning curve, thus confirming the initial implication and allowing the time contribution from equation (5) to be safely zeroed-out, and consequently from equation (1) as well, finally obtaining:

$$x \left(t\right) = {\sum }_{N} {\text{wx}}^{c} + {\sum }_{K} {\text{w}}^{i n} \text{u} \left(t\right) , \qquad \text{(6)}$$

where x^{c} is the constant term that represents all reservoir states. Besides the accuracy disparity, the recurrent configurations fluctuate more than the non-recurrent ones.

### Result 2: Binary Synapses Enable Ad Hoc Neuronal Models

Since the introduction of the first perceptron model, artificial neurons have previously been modeled into two fundamental logic blocks:
The first one, the MAC unit, accepts all incoming connections (or synapses) and produces a single numeric value that represents the weighted sum of all its contributions. Basically, the neuron performs equation (6).
The second component, called activation function, performs a transformation of the weighted sum in order to derive the final excitatory state of the neuron.

Typically, activation functions are empirically selected according to the type of problems the final user wants to solve. In the context of RCNs, the most popular choices include Sigmoid (or Logistic), tanh (or hyperbolic tangent), or a combination thereof.

$$s i g m o i d \left(\text{x}\right) = \frac{1}{1 + {e}^{- x}}$$

$$t a n h \left(\text{x}\right) = \frac{2}{1 + {e}^{- 2 x}} - 1 \qquad \text{(7)}$$

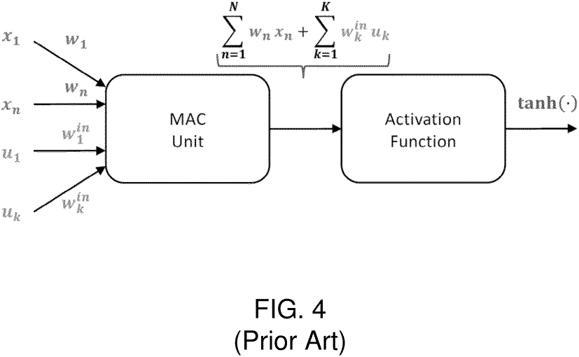

Having x in equation (7) represents the result of the MAC operation, and activation functions by themselves can imply a complicated computational workload (visually conveyed in FIG. 4) which hardly fits arithmetic capabilities of resource-constrained devices, a condition that persists despite applying aggressive (e.g., power-of-two, ternary, or even binary) quantization strategies. However, neural networks themselves do not allow a complete exploitation of the binary domain. In fact, the weights of a neural networks may follow a Gaussian distribution with zero mean. As a consequence, weights can assume positive and negative values with the same probability. At the same time, forcing weights to assume only positive values may lead to suboptimal accuracy performance, since this directly translates into a substantially reduced learning exploration space (or may be even leading to the resurface of the Gradient Vanishing Problem). Therefore, such a constraint is in direct opposition to what a purely binary neural network would be able to represent, i.e., weights and activations defined in B (Boolean).

### Boolean RCN Architecture

With these considerations in mind, the present technology uses a Boolean reservoir layer that uses activations and weights in B (Boolean) and leverages neurons based on a specific family of logic functions or logic gates. The Boolean logic reservoir may be a revised Boolean RCN architecture that exploits the compactness and the expressive power inherent in this technology.

### XOR-Based Neuron

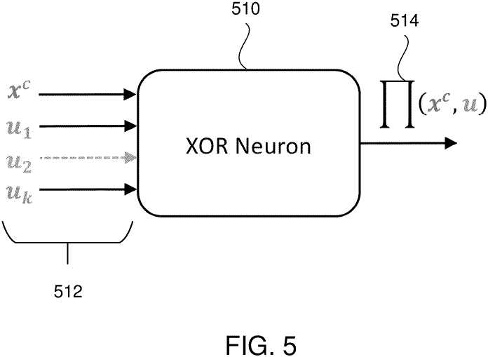

FIG. 5 depicts an example of a binary neuron configuration for this technology. As the diagram suggests, there is a single logic block that may compose the neuron 510 and this logic block can be an XOR gate. All incoming connections 512 represent either states coming from other neurons or primary inputs and may be subject to an XOR operator. Since the output of the XOR operator is a 0 or 1, then there is no need for a final activation function. The connection u₂ has an equivalent weight of zero. More formally, x is the incoming state values from upstream neurons, u is for the primary inputs, and w and wⁱⁿ are for the weights for the hidden connections and for the inputs respectively. It is possible to describe the equivalent neuronal functionality as:

$$x \left(t\right) = \prod \left({\sum }_{N} w {x}^{c} , {\sum }_{K} {w}^{i n} u \left(t\right)\right) , \qquad \text{(8)}$$

where II 514 represents the bit-wise XOR operator. The MAC operator in equation (8) is required iƒƒ a weight can be associated to incoming synapses. Since an aspect of this technology is to rely on pure Boolean logic, a given synapse (both one that connects two neurons, or one that connects a primary input to a neuron) has a weight value equal to 1 iƒƒ that connection actually exists. Otherwise, (i.e., if there is no connection) the synapse’s associated weight will be regarded as null. In other words, weight values can be embedded in the topology of the reservoir itself, which, in turn, can lead to the simplification of equation (8) in:

$$x \left(t\right) = \prod {\text{x}}^{c} , {\text{u}}^{\left(\left(t\right)\right)} . \qquad \text{(9)}$$

Furthermore, the term X^{c} is a constant term neuron-wise. In fact, according to the discussion above, leveraging the previous memory of the system when inferring independent input patterns can have negative effects on the quality of results (QoR) (refer to the example in FIG. 3). For this reason, the states of the neurons can be “frozen” at the beginning of a classification run (e.g., random states can be assigned when the network is generated) and then the x^{c} values can be pre-computed accordingly. This not only simplifies equation (9), but the deriving Boolean reservoir will not be affected by closed loops, which will otherwise likely represent a serious race condition. The constants can be used because time series data is not being processed. In addition, this neural network structure may be more linear due to the constants.

### Boolean Logic Reservoir Architecture

To leverage the neuron illustrated in FIG. 5, we refer back to the modified RCN architecture depicted in FIG. 1. This technology leverages a more complex, therefore more powerful, readout composed of cascading dense layers, so as to form a fully-connected readout layer 130 network. Thus, the hidden layer or Boolean reservoir 120 is much simpler since, as discussed earlier, each of its nodes or neurons is composed of an equivalent XOR gate (or a similar balanced function) that takes input stimuli and interconnected neurons’ states to determine its final excitatory state, as reported in equation (9). This Boolean RCN architecture may shift the complexity from the reservoir layer (e.g., the Boolean reservoir 120) to the readout layer 130.

In addition, past neural network models (whether a deep or shallow network) used a lot of computation for MAC processing and the activation processing. The neurons in this improved neural network do not use a dot product computation (MAC) or an activation function. By removing the random connections usually found in a CNN or RCN and providing constants in the place of those connections, this change simplifies the neuron structure. This technology reduces the use of a large amount of computation in the feature extraction phase or reservoir layer, as compared to prior CNN or RCN models. The Boolean reservoir layer can replace the reservoir of an RCN with simpler and more readily hardware synthesizable structure.

### Generating a Boolean Logic Reservoir

The pseudo-code below shows an example of high level steps for generating the Boolean reservoir.

Boolean Reservoir Build Function
Input: Input shape Iₛ, Number of nodes Ξ, Sparsity ρ
Output: Boolean reservoir graph Ψ
1 Ψ = binomial_graph(Ξ, ρ)
2 foreach node ξ ∈ Ξ do
3 ζ ← randomstate()
4 end
5 foreach input i ∈ Iₛ do
6 new_node ← empty_node(i)
7 Ψ ← create_random_synapses(new_node)
8 end

The function uses certain parameters: the input shape Iₛ, namely the dimension of the input, the number of hidden neurons or nodes Ξ, and the sparsity ρ, i.e., the percentage of synapses to be removed from the graph. The first step of the routine is creating a binomial graph (derived from the Erdo ̋s-Rényi model) having the specified number of neurons and the required sparsity. For each of the nodes that compose the graph, a binary state is randomly assigned (line 3). For each input stimuli i ∈ Iₛ, a new placeholder node can be created, which may then be randomly connected to another neuron node already instantiated in Ψ. As a result, the input connections towards the reservoir are sparse connections. Ψ is then returned to the calling function for further processing. The furth process may entail a behavioral Verilog annotation of the equivalent reservoir network by means of an existing logic synthesis tool, (e.g., ABC), that effectively performs logic optimizations using well established Boolean minimization rules.

When building the Boolean Reservoir, the self-connections and feedback loops are removed from the neurons or nodes. These self-connections are not needed with non-time series data because there is no need to store what happened in the past, as would be the case with time series data. As discussed already, no MAC unit is used in the reservoir layer. Each neuron may have one logic gate that is an XOR gate or a balanced output Boolean function.

Inputs that exist have a weight of one, and connections that do not exist are weight zero. As a result, the neuron does not need a separate activation function or weighting. Removing weightings avoids executing computing resource consuming weight computations to perform the feature extraction. This Boolean reservoir layer can be written to a design flow that is synthesizable as a hardware design.

An example implementation obtained for the Boolean RCN will now be described. In order to evaluate the performance of this technology, we consider the F-MNIST dataset, a well known test data set, which includes: a collection of 28×28 grayscale pictures depicting 10 different types of clothing, such as shoes, t-shirts, dresses, and others. From the picture dataset, 60k images are used for training, while the remaining 10k are used for validation. Before employing the aforementioned dataset, the images can first be ported to the binary domain via a pixel-wise threshold comparison of a conversion function: pixels brighter than 128 (e.g., on a scale of 0 to 255) are set to 1, otherwise they are put to 0. Of course, any value may be selected for the threshold comparison depending on the data set and distribution of values in the images of the dataset.

A Boolean RCN network that has 400 XOR neurons in the reservoir and a three-layer fully-connected readout having 1024 + 120 + 10 neurons is tested against the F-MNIST dataset. For the sake of comparison, two state-of the-art CNN models, MobileNetV2 and EfficientNetV2, can be used. Both of these CNNs are trained and tested with the same F-MNIST dataset.

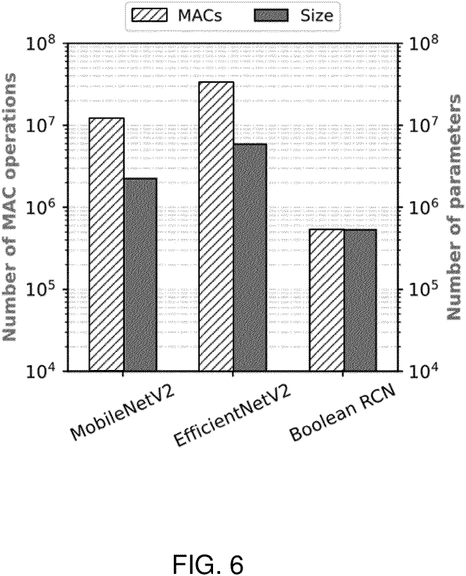

MobileNetV2, EfficientNetV2, and the Boolean RCN achieved 90%, 87%, and 84% respectively on the considered dataset. FIG. 6 summarizes other key metrics that put Boolean RCNs in perspective. In particular, the bar plot has a double y-axis where the number of MAC operations aligns to the left axis (cross hatched bars), and the total number of trainable parameters aligns to the one on the right (solid bars). As the plot suggests, the Boolean RCN implementation uses 22x and 61x fewer MACs as compared to MobileNetV2 and EfficientNetV2, respectively. This is in part due to the structure of the Boolean RCN, which, by design, is not a compute-bound entity. Additionally, having a reservoir that requires no MAC operations allows to keep the computational workload very close to the number of trainable parameters. Concerning the latter, the Boolean RCN guarantees a remarkable predictive performance while employing 4x fewer parameters than MobileNetV2 and 11x fewer parameters than EfficientNetV2. This result demonstrates the higher suitability of Boolean RCN for resource-constrained devices.

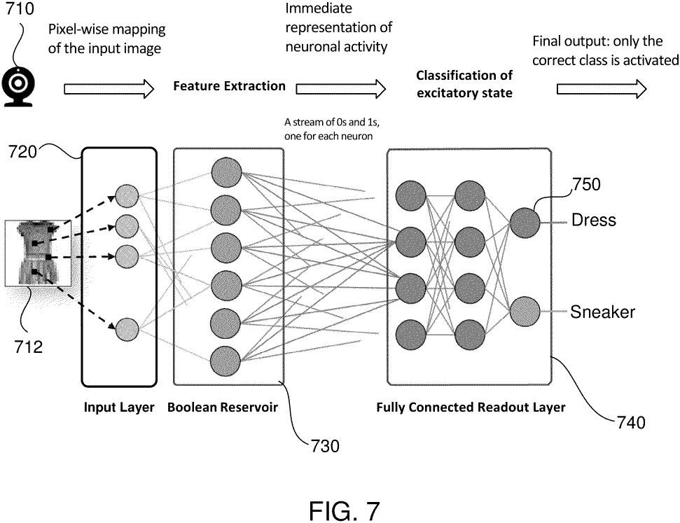

FIG. 7 illustrates the use of a Boolean RCN in the context of an image processing application. For example, an image may be captured using a camera 710. The image may have captured an image of an article of clothing 712, such as the dress illustrated. This image may be mapped pixel-wise to an input layer 720. The input image may then be sent to the Boolean reservoir 730 which will provide feature extraction, as discussed earlier. The excited state in the Boolean reservoir may be classified in the fully connected readout layer 740. As illustrated, an output neuron 750 may be the output that defines the classification of a dress.

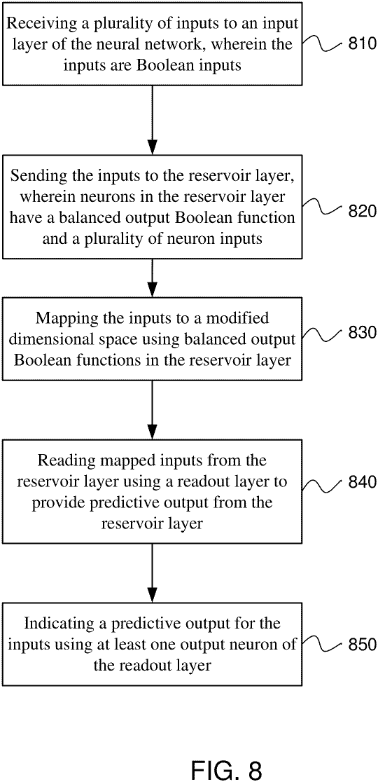

FIG. 8 is a flow chart diagram illustrating a method for processing data using a Boolean reservoir in a Boolean RCN. The method can include the operation of receiving a plurality of inputs at an input layer of the neural network, wherein the inputs are Boolean inputs, as in block 810.

If the incoming input pattern is already in binary form, then the input data or input pattern may be used without any changes. In some other cases, a conversion may need to be applied to an input pattern to convert the input pattern to a binary form. For example, a conversion function may be applied to preprocess an input dataset from grayscale (i.e., black and white images where each pixel can assume a value [0, 255]) or color into binary values, since a fully binary version of that dataset may not be available. This conversion may occur by converting input values for the inputs to a zero or one using a threshold comparison value. More specifically, input values may be converted to zero when an input value from a grayscale image is less than or equal to a threshold value. Input values may be converted to a one when an input value from the grayscale image is greater than the threshold value.

The inputs can be sent to the Boolean reservoir or reservoir layer, as in block 820. Neurons in the Boolean reservoir may have a balanced output Boolean function with a plurality of neuron inputs. The balanced output Boolean function may be: an exclusive OR (XOR) Boolean function, a majority Boolean function (MAJ), minority Boolean function (MIN), an exclusive NOR (XNOR) function, or any Boolean function with a balanced output. In the case of an XOR function, each XOR is also independent from the other XOR functions. Each neuron focuses on a specific part of the network and has an excitable state based on the input from that part of the network. In some examples, the balanced output Boolean function may be fabricated using hardware gates in an integrated circuit (IC), an ASIC (Application Specific Integrated Circuit), programmed into a FPGA (Field Programmable Gate Array) or another hardware development process or methodology. In addition, some or all of the layers of the present invention may be implemented as hardware gates, in software or in a hybrid mix of hardware and software.

This technology provides a logic design that is straight forward to map into LUTs (look up tables) in a FPGA or other computing hardware design. In addition, the Boolean reservoir does not need memory components for use during the feature extraction (as compared to RCN networks). Convolutional networks can consume up to 80% of the overall logic structure of the CNN. Removing the convolution network and replacing the convolutional network with a Boolean reservoir can remove the complexity from the overall neural network. The readout layer may still use memory for readout and is memory bound. However, the readout layer uses only 20% of the memory that may be used by a convolutional network for an application.

A further operation may be mapping the inputs to a modified dimensional space using balanced output Boolean functions in the Boolean reservoir, as in block 830. A mapping of the inputs to a modified dimensional space may be mapping of the inputs into an increased dimensional space or decreased dimensional space of the Boolean reservoir to perform feature extraction.

The reservoir layer may be initialized with random values prior to execution. In addition, the reservoir layer may be initialized by removing synapses to other neurons from a graph and removing self-connections for neurons. One input for each neuron may be a constant representing input from at least one upstream neuron with a value that was defined at a time of reservoir layer initialization. The constants depend on the Boolean reservoir structure that is initially generated. The values may be set based on the interconnected neurons after the Boolean reservoir is first initialized. The Boolean reservoir may obtain the constant value once and keep the constant value during the entire processing period.

In some configurations, the Boolean reservoir may not be trained before use. However, in some cases, once the reservoir is initialized, a training algorithm or method may be applied to the Boolean reservoir to train the Boolean reservoir for some desired behavior.

Mapped inputs from the reservoir layer may be read using a readout layer to provide predictive output (e.g., classification, regression, etc.) from the reservoir layer, as in block 840. Many types of classifiers may be used in the readout layer for reading the inputs from the Boolean reservoir layer. For instance, the readout layer may use Random Forests, Classification Trees, Support Vector Machines, and any other AI (artificial intelligence) technique or model capable of performing a classification task. In addition, any AI technique may possibly be used to perform a regression in the readout layer in order to estimate a relationship or outcome of a dependent variable with respect to a group of independent variables. The readout layer may be considered as interpreting the state of the Boolean reservoir that is a hidden network layer. Accordingly, predicative output can be used that classifies input from the hidden layer or applies regression to the input from the hidden layer. Furthermore, the readout layer may provide any type of predictive modeling output.

The readout layer may be trained using a plurality of training cases. Then a difference between a predicted output and an actual expected output may be minimized through the training to provide the desired output from the readout layer.

A predictive output (e.g., classification or regression) for the inputs may be indicated using at least one output neuron of the readout layer, as in block 850. In some configurations, there may be a number of output neurons that correspond to the number of classifications to be made. As an example, there may be 10 possible classifications, and then 10 possible output neurons may be provided with a neuron for each classification.

Many types of classification and/or regression tasks can be accomplished with this technology as long as the inputs are not time-dependent and the input data or input patterns can be converted to binary form. Such conversion to binary form may be performed either via a simple thresholding or via more complex quantization techniques. Examples of inputs may be input values representing at least one of: an image, a video stream, a sound clip, or an alpha numeric value. Further, audio and/or video data may be processed by the technology. For instance, frequencies of a sound clip can be represented as a sequence of Os and 1 s. Video streams can also be regarded as a sequence of still images/frames that are not time-dependent, hence this method and system may be applied to such still images or frames. Any applications suitable for classification or regression tasks (assuming the data representation is compliant to the criteria above) may be processed using the present technology.

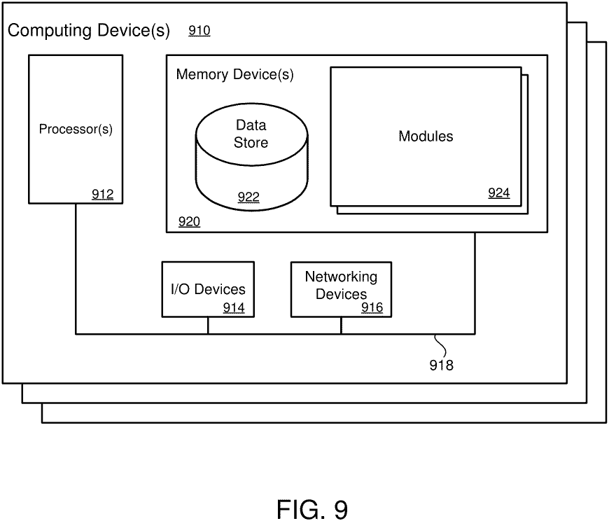

FIG. 9 illustrates a computing device 910 on which modules or layers of this technology may execute. A computing device 910 is illustrated on which a high-level example of the technology may be executed. The computing device 910 may include one or more processors 912 that are in communication with memory devices 912. The computing device may include a local communication interface 918 for the components in the computing device. For example, the local communication interface may be a local data bus and/or any related address or control busses as may be desired.

The memory device 912 may contain modules 924 that are executable by the processor(s) 912 and data for the modules 924. The modules 924 may execute the functions described earlier. A data store 922 may also be located in the memory device 912 for storing data related to the modules 924 and other applications along with an operating system that is executable by the processor(s) 912.

Other applications may also be stored in the memory device 912 and may be executable by the processor(s) 912. Components or modules discussed in this description that may be implemented in the form of software using high programming level languages that are compiled, interpreted or executed using a hybrid of the methods.

The computing device may also have access to I/O (input/output) devices 914 that are usable by the computing devices. An example of an I/O device is a display screen that is available to display output from the computing devices. Other known I/O device may be used with the computing device as desired. Networking devices 916 and similar communication devices may be included in the computing device. The networking devices 916 may be wired or wireless networking devices that connect to the internet, a LAN, WAN, or other computing network.

The components or modules that are shown as being stored in the memory device 912 may be executed by the processor 912. The term “executable” may mean a program file that is in a form that may be executed by a processor 912. For example, a program in a higher level language may be compiled into machine code in a format that may be loaded into a random access portion of the memory device 912 and executed by the processor 912, or source code may be loaded by another executable program and interpreted to generate instructions in a random access portion of the memory to be executed by a processor. The executable program may be stored in any portion or component of the memory device 912. For example, the memory device 912 may be random access memory (RAM), read only memory (ROM), flash memory, a solid-state drive, memory card, a hard drive, optical disk, floppy disk, magnetic tape, or any other memory components.

The processor 912 may represent multiple processors and the memory 912 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer, and similar systems.

Some of the functional units described in this specification may have been labeled as modules or layers, in order to more particularly emphasize their implementation independence. For example, a module or layer may be implemented as a hardware circuit comprising custom VLSI circuits or gate arrays, off-the-shelf semiconductors such as logic chips, transistors, or other discrete components. A module or layer may also be implemented in programmable hardware devices such as field programmable gate arrays, programmable array logic, programmable logic devices or the like.

Modules or layers may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for processing data using a Boolean reservoir, comprising:
receiving a plurality of inputs to an input layer of a neural network, wherein the inputs are Boolean inputs;
sending the inputs to a reservoir layer, wherein neurons in the reservoir layer have a balanced output Boolean function and a plurality of neuron inputs;
mapping the inputs to a modified dimensional space using balanced output Boolean functions in the reservoir layer; and
reading mapped inputs from the reservoir layer using a readout layer in order to provide predictive output.

2. The method as in claim 1, further comprising indicating a predictive output for the inputs using at least one output neuron of the readout layer.

3. The method as in claim 1, wherein the balanced output Boolean functions are at least one of: an exclusive OR (XOR) Boolean function, a majority Boolean function (MAJ), minority Boolean function (MIN), an exclusive NOR (XNOR) function, or a Boolean function with a balanced output.

4. The method as in claim 1, further comprising initializing the reservoir layer with random values.

5. The method as in claim 1, further comprising initializing the reservoir layer by removing synapses from a graph to other neurons and removing self-connections for neurons.

6. The method as in claim 5, wherein one input for each neuron is a constant representing input from at least one upstream neuron with a value that was defined at a time of reservoir layer initialization.

7. The method as in claim 1, wherein mapping the inputs to a modified dimensional space further comprises mapping the inputs into an increased dimensional space or decreased dimensional space to perform feature extraction.

8. The method as in claim 1, wherein the readout layer performs a classification or regression.

9. The method as in claim 1, further comprising training the readout layer using a plurality of training cases and minimizing a difference between a predicted output and an actual expected output through training.

10. The method as in claim 1, wherein the inputs are input values representing at least one of: an image, a video stream, a sound clip, or an alpha numeric value.

11. The method as in claim 1, wherein the balanced output Boolean function are fabricated using hardware gates of an ASIC (Application Specific Integrated Circuit) or programmed into a FPGA (Field Programmable Gate Array).

12. A system for processing data using a Boolean reservoir, comprising:
at least one processor;
at least one memory device including a data store to store a plurality of data and instructions that, when executed, cause the system and processor to:
receive a plurality of inputs to an input layer, wherein the inputs are Boolean inputs;
send the inputs to a data reservoir of a Boolean reservoir layer, wherein neurons in the Boolean reservoir layer are balanced output Boolean functions with a plurality of neuron inputs;
map the inputs to a modified dimensional space using the neurons of the Boolean reservoir layer;
read mapped signals using a readout layer to provide predictive output from the Boolean reservoir layer; and
indicate a classification of the inputs at an output neuron of the readout layer.

13. The system as in claim 12, wherein a balanced output Boolean function is at least one of: exclusive OR (XOR) Boolean function, a majority Boolean function (MAJ), minority Boolean function (MIN), an exclusive NOR (XNOR) function, or a Boolean function with balanced output.

14. The system as in claim 12, further comprising initializing a reservoir layer that is non-trainable with random values.

15. The system as in claim 14 wherein one input for each neuron is a constant representing input from another neuron with a value that was defined when the reservoir layer is initialized.

16. The system as in claim 12, wherein mapping the inputs to a modified dimensional space further comprises mapping the inputs into an increased dimensional space or decreased dimensional space.

17. The system as in claim 12, further comprising converting input values of the inputs to a zero or one using a conversion function.

18. A non-transitory machine readable storage medium including instructions embodied thereon for processing data using a Boolean reservoir, wherein the instructions, when executed by at least one processor:
receive a plurality of inputs to an input layer, wherein the inputs are Boolean inputs;
send the inputs to a reservoir layer, wherein neurons in the reservoir layer have exclusive OR (XOR) Boolean functions with a plurality of neuron inputs;
map the inputs to a modified dimensional space in the reservoir layer using exclusive OR (XOR) Boolean functions;
read a mapped signal using a readout layer to provide predictive output from the reservoir layer; and
indicate a classification of the inputs at an output neuron of the readout layer.

19. The non-transitory machine readable storage medium as in claim 18, wherein the instructions further initialize the reservoir layer with random values.

20. The non-transitory machine readable storage medium as in claim 19, wherein one input for each neuron is a constant representing input from another neuron with a value that was defined when the reservoir layer was initialized.

21. The non-transitory machine readable storage medium as in claim 18, wherein the instructions to map the inputs to a modified dimensional space further comprise mapping the inputs into an increased dimensional space or decreased dimensional space.

22. The non-transitory machine readable storage medium as in claim 18, wherein the instructions further convert input values of the inputs to a zero or one using a conversion function.
